(19) United States
(12) Patent Application Publication
(10) Pub. No.: US 2013/0078342 A1
(43) Pub. Date: Mar. 28, 2013

(54) COFFEE MAKER

(71) Applicant: Oded Loebl, Newton, MA (US)

(72) Inventor: Oded Loebl, Newton, MA (US)

(21) Appl. No.: 13/700,732

(22) PCT Filed: Jun. 1, 2011
(86) PCT No.: PCT/US11/38803

§ 371 Date: Nov. 29, 2012

Related U.S. Application Data
(60) Provisional application No. 61/350,040, filed on Jun. 1, 2010.
(60) Provisional application No. 61/375,882, filed on Aug. 23, 2010.

(51) Int. Cl. A47J 31/36; A23F 5/26; B65D 85/804

(52) U.S. Cl. CPC A47J 31/36; B65D 85/8043; A23F 5/262
USPC 426/115; 99/283; 426/433

(57) ABSTRACT

Methods and apparatus for a coffer maker. A beverage preparation apparatus includes a coffee link chamber for receiving coffee grounds and water, a coffee receiving chamber for receiving prepared coffee, the heating source operative check heat for coffee brewing chamber, at least one biasing element formed of a shape memory materials, and at least one piston element couples to the biasing element, whereby when the coffee brewing chamber reaches a transition temperature of the shape memory material, a biasing element deforms, releasing a spring force urging the piston element into the coffee brewing chamber to decrease the volume and increase the pressure within the coffee brewing chamber, and forcing heated water through the coffee grounds through a filter and into a coffee collection container situated in the coffee receiving chamber.

### CROSS-REFERENCE TO RELATED APPLICATIONS

This application claims the benefit of U.S. Provisional Application No. 61/350,040, filed Jun. 1, 2010, and titled “Novel Coffee Maker,” and U.S. Provisional Application No. 61/375,882, filed Aug. 23, 2010, and titled “Coffee Preparation Apparatus,” which are both incorporated by reference in their entirety.

### BACKGROUND OF THE INVENTION

The present invention relates to drink preparation, and more particularly to a coffee maker.

The popularity of coffee and espresso drinks has grown recently, and in-home espresso machines are becoming more and more commonplace. These drinks conventionally have been prepared by brewing, where hot water passes through coffee grounds above a filter, under pressure in the case of espresso machines. Indeed, a defining characteristic of electrical espresso machines is that the coffee grinds are infused with hot water under a substantially constant high pressure supplied by an electrical pump. The hot water pressure is usually more than 100 pounds per square inch (psi) throughout the infusion/extraction cycle.

Typically, espresso machines for home use are larger than about 14 inches high, 10 inches long and 8 inches deep, weigh more than 20 pounds, and require more than 1 kilowatt (kW) power to operate. The minimum size and weight of espresso machines are in part limited by the process used to prepare expresso. For instance, the water is completely unheated before entering a pump area and is heated to the espresso temperature in a single step by a boiler or thermo-block. This requires a large volume of heated water in the boiler, and thus a powerful heater is necessary. Indeed, the water typically must be heated to about 205° F. (96° C.) in about 20 seconds, which is the optimum brewing time for espresso; this temperature is sometimes labeled as A_{f}. Also, for temperature stability, the volume of the boiler is typically at least four times the volume of the prepared coffee, and components such as the boiler, group, and portafilter are typically made of heavy cast metal.

### SUMMARY OF THE INVENTION

The present invention provides methods and apparatus for a coffee maker.

In general, in one aspect, the invention features a beverage preparation apparatus including a coffee link chamber for receiving coffee grounds and water, a coffee receiving chamber for receiving prepared coffee, the heating source operative check heat for coffee brewing chamber, at least one biasing element formed of a shape memory materials, and at least one piston element couples to the biasing element, whereby when the coffee brewing chamber reaches a transition temperature of the shape memory material, a biasing element deforms, releasing a spring force urging the piston element into the coffee brewing chamber to decrease the volume and increase the pressure within the coffee brewing chamber, and forcing heated water through the coffee grounds through a filter and into a coffee collection container situated in the coffee receiving chamber.

In another aspect, the invention features a beverage preparation capsule including multiple compartments separated by dividers, at least one of the dividers comprising coffee grounds, wherein the capsule is inserted into a coffee brewing chamber of a coffee preparation apparatus, the capsule punctured by a puncturing element at a predetermined time, thereby releasing the coffee grounds to enable the percolation thereof.

In another aspect, the invention features a coffee preparation method including inserting coffee grounds and water into a coffee brewing chamber of a coffee preparation apparatus, heating the coffee brewing chamber with a heating source, deforming a biasing element formed of a shape memory materials, when said coffee brewing chamber reaches a transition temperature of said shape memory material, releasing a spring force that urges a piston element into the coffee brewing chamber to decrease the volume and increased the pressure within the coffee brewing chamber, and forcing heated water through the coffee grounds through a filter and into a coffee collection container situated in a coffee receiving chamber of the coffee preparation apparatus.

Other features and advantages of the invention are apparent from the following description, and from the claims.

### BRIEF DESCRIPTION OF THE DRAWINGS

The invention will be more fully understood by reference to the detailed description, in conjunction with the following figures, wherein:

FIG. 1 is a diagram of an exemplary beverage preparation apparatus.

FIG. 2 is a diagram of an exemplary beverage preparation apparatus.

FIG. 3 is an exploded view of a lid.

FIG. 4 is an exploded view of the lid.

FIGS. 5, 6, 7 and 8 illustrate example spring configurations.

FIGS. 9 and 10 illustrate a chamber.

FIG. 11 illustrates the lid locked to the central body.

FIGS. 12 and 13 illustrate two phases of a SMA component.

FIG. 14 illustrates an additional spring configuration.

FIGS. 15 and 16 illustrate an exemplary beverage preparation apparatus.

FIGS. 17 and 18 illustrate an exemplary beverage preparation apparatus.

FIGS. 19 and 20 illustrate an exemplary retrofitted moka pot/macchinetta.

FIG. 21 illustrates a spring and lever configuration.

FIGS. 22 and 23 illustrate an exemplary beverage preparation apparatus.

FIGS. 24-41 illustrate a multi-chambered capsule.

FIG. 42 is a flow diagram.

Like reference numbers and designations in the various drawings indicate like elements.

### DETAILED DESCRIPTION

The present invention relates to a compact, uncomplicated and trouble-free coffee maker that can be used to brew expresso coffee and so forth. With expresso, the coffee maker fully described herein can be utilized with a single shot of expresso or for multiple shots of expresso. A miniature, temperature controlled pump delivers approximately 10 bars of pressure when the water reaches approximately 90° C. Variations can be used on a stove top, a counter top and in a vehicle.

The invention fully described herein relates to a compact, uncomplicated and trouble-free beverage preparation apparatus. In one example, the beverage preparation apparatus described herein is used to prepare espresso type coffee. The invention further discloses a capsule for aiding in the preparation of beverages such as espresso. Also described herein is a method for brewing a beverage, such as espresso, which closely meets the requirements and standards for the production of a high quality espresso product. As described herein, the beverage preparation apparatus may be used to produce a single shot of expresso, short, standard or long, or for multiple shots of expresso.

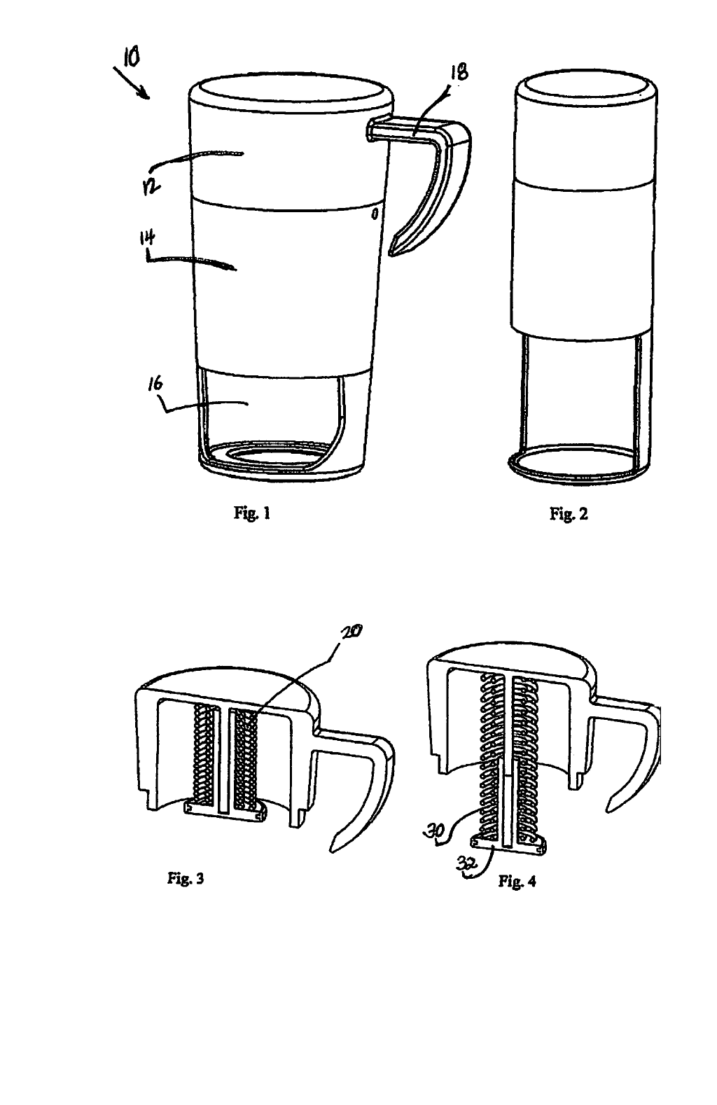

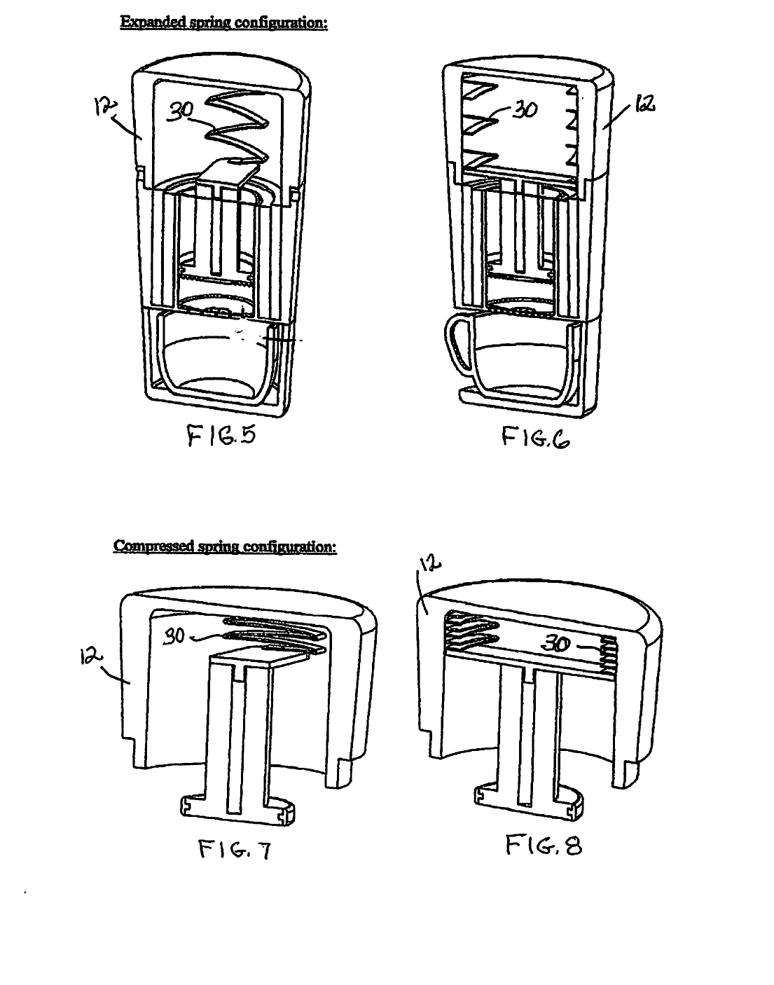

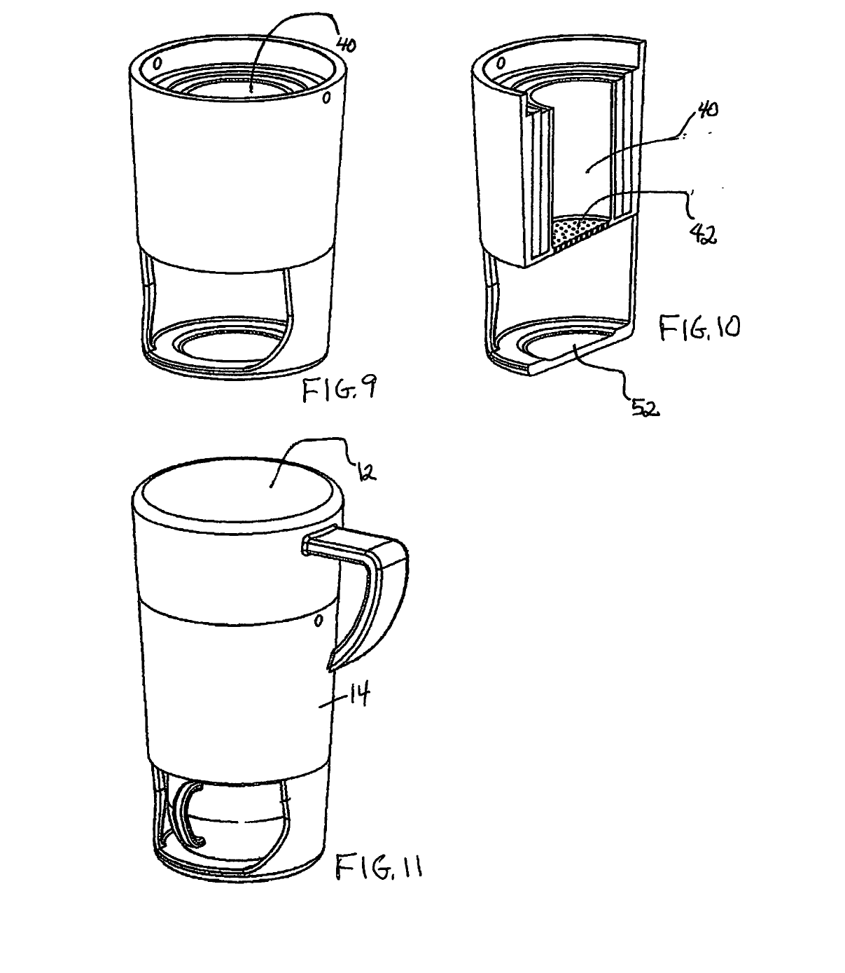

As shown in FIG. 1, an exemplary beverage preparation apparatus 10 includes a top 12, sometimes referred to as a lid, a central body or chamber 14 and a base 16, sometimes referred to as a cup holder. A shape of the beverage preparation apparatus 10 may resemble a thermal coffee cup (including an optional handle 18) that fits into a cup holder of a car, truck, boat, and so forth.

As shown in FIG. 2, an exemplary beverage preparation apparatus 20 is shaped for use in a location other than a vehicle, such as, anywhere a small espresso maker might be located, such as a residence, office, restaurant, coffee shop, cafe and so forth. The beverage preparation apparatus 20 may stand freely on surface such as a table or counter, or be placed in a stand with supporting members such as legs or tripod, so that the apparatus 20 is stable on the surface.

As shown in FIG. 3, inside the lid 12 of beverage preparation apparatus 10 there resides one or more shape memory alloy (SMA) components 30, such as a nickel-titanium alloy, sometimes referred to as “Nitinol”), which, when reaching a requisite temperature Af, changes shape, e.g., expands or contracts. Here, the SMA component 30 is shown in its compressed phase surrounding a piston 32 (also referred to as a plunger).

As shown in FIG. 4, the SMA component 30 is shown in an expanded state, which advances the piston 32.

As shown in FIGS. 5 6, 7 and 8, the SMA component 30 may be a spring or springs that can be made of strip/flat wire or any other cross-sectional shape. The spring may be a matrix of springs in parallel, in series or a combination of parallel and series. The spring configuration (s) can be leaf springs, hair pins stacked Belleville/curved spring washers, helical springs, constant or variable pitch, volute, or other spring type and/or combination/configuration.

Referring again to FIGS. 1 and 2, a locking mechanism may be located between the top 12 and the central body 14. The locking mechanism may be a tread, bayonet, hinge and latch, or any suitable mechanism to fixate the top 12 and central body 14.

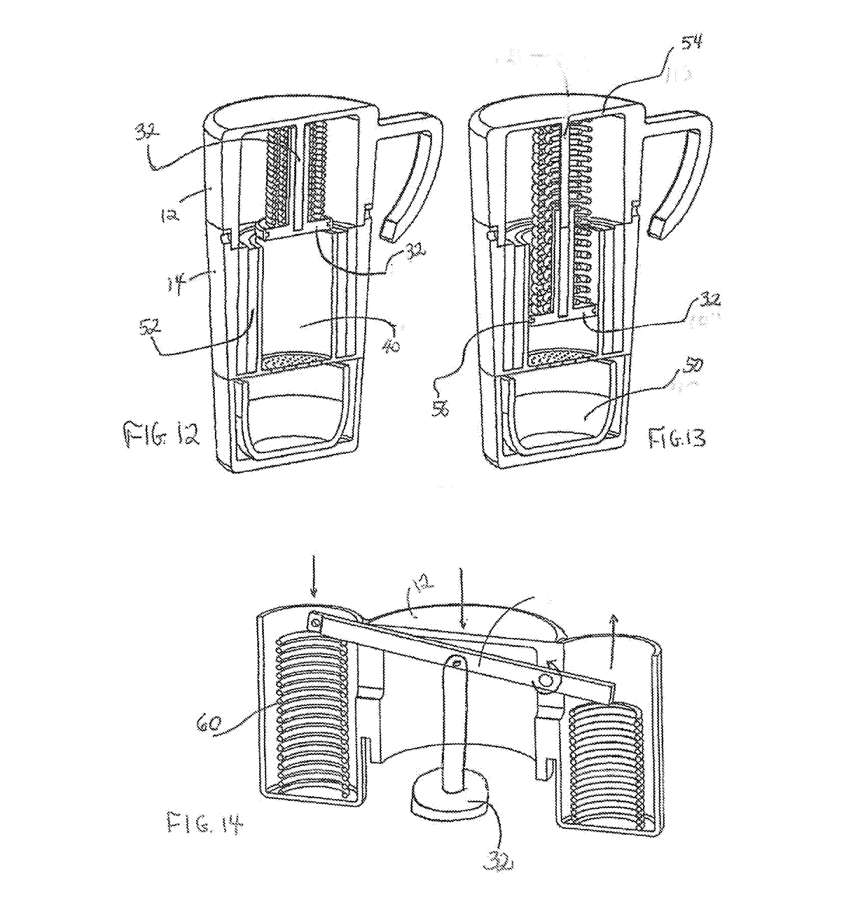

As shown in FIGS. 9 and 10, when the lid 12 is unlocked and removed from the apparatus 10, there is a chamber 40 in the center of the body of the apparatus 10 for inserting espresso and water. The espresso may be in the form loose ground coffee, pods, such as Easy Serving Espresso Pods (ESE) or capsules/cartridges, both single and multi-chambered. On a bottom of the chamber 40 there is a surface 42 with a number or holes or perforations, and optionally, pins or nails (not shown). A configuration of the holes (and pins/nails, if present) and location (for puncturing capsules) is correlated with the form of the coffee used. For example, if loose ground coffee is used, the holes should be a finer mesh than if using a pod since the porous pod bag retains the loose ground coffee. In should be noted that some capsules ate not sealed and enable water to flow through, while some capsules need a pin or nail to enable the water to flow through.

After inserting the coffee, sufficient water is added to the chamber 40 depending on shot size. Optionally, a multi-chambered capsule may be inserted into the chamber 40 and a cover/peel off lid removed. Optionally, a cylindrical insert of various heights may be inserted into the chamber 40 to change a volume of the water, and therefore a shot size. As shown in FIG. 11, the lid 12 is placed on the central body 14 and locked into position.

As shown in FIG. 12, when the lid 12 is placed on and locked to the central body 14, the piston 32 is positioned directly over the filled chamber 40. An espresso (or other) cup 50 is placed in the base 16. There may be a contoured depression 52 (FIG. 10) on the base 16 for easy positioning of the cup 50 and for stabilizing the cup 50. The base 16 may include an optional heat source to warm a contents of the cup 50.

It should be noted that electrical components of the apparatus 10 are not illustrated in the figures since the circuit is simple. The apparatus 10 is turned on after inserting a power cord to an electrical source such as a wall socket, car lighter plug, battery pack and so forth. Optionally, the apparatus may be heated by another heat source.

A heating element 52 that surrounds the chamber 40 heats to a predetermined temperature. When the water reaches the requisite temperature, the SMA component 30 changes phase (either by absorbing heat radiated from the heating element 52 or having an electric current pass through the SMA component 30, or a combination thereof) causing the SMA component 30 to elongate, as shown in FIG. 13.

The elongation pushes the SMA component 30 on one side against a top inner surface 54 and on the other side against the piston 32. The piston 32, which has a seal or o-ring 56 that forms a watertight seal with the chamber 40, advances into the chamber 40 and forcefully pushes the heated water through the coffee, through the holed surface 42 and out into the cup 50. Optionally, there may be a funnel that directs the flow into the cup 50. The o-ring 56 may be positioned at various points around the chamber 40. In some embodiments, a second o-ring is added to increase stability of the piston 32 when moving and to help maintain concentricity of the piston 32 in the chamber 40.

The lid 12 may then be opened. The SMA component 30 will passively cool below the Af after which the SMA component 30 may be compressed back into its original position in the lid 12. In some example, the SMA component 30 can be actively cooled using a cooling apparatus, such as a cooling/Peltier diode, thermoelectric cooler, and so forth.

Alternatively, there may be an additional spring connected to the piston 32 that applies a constant compressive force to overcome the cooled SMA component 30 and raise the piston 32 back into the lid 12. As shown in FIG. 14, one spring may be an SMA component 30 and another spring 60 may be a standard spring that pushes an arm 62 and raises the piston 32 back into the lid 12. Alternatively, there may be a strip/string/cable/wire or similar that is connected to a center of the piston 32 from above and travels through the piston 32 and centering axis and out the top of the lid 12. By pulling the string/cable using manual, mechanical, electrical or other force, the piston 32 is pushed into the lid 12 in its original state.

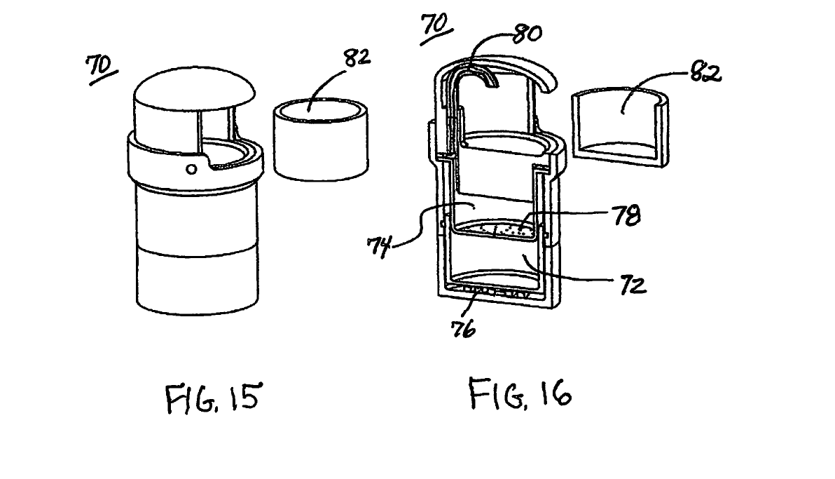

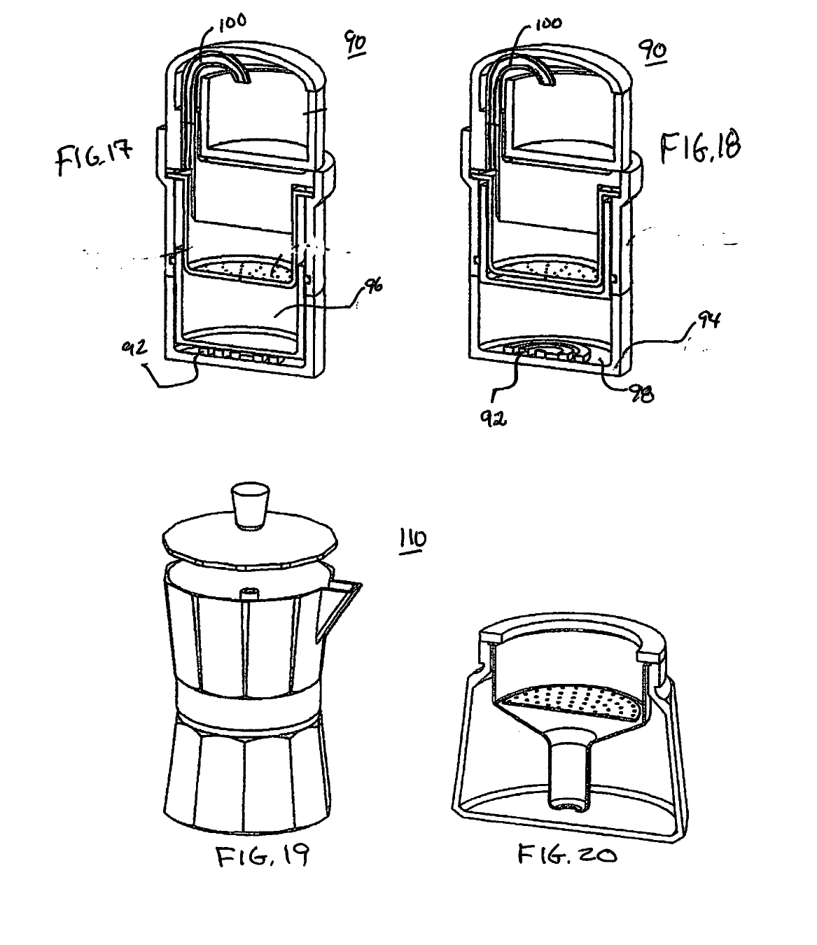

As shown in FIGS. 15 and 16, an exemplary beverage preparation apparatus 70 includes a water chamber 72 positioned under a coffee chamber 74. A SMA component 76 pushes (or pulls) the water chamber 72 upwards, causing water to pass through the perforated plate 78, through the coffee grinds, up through a spout 80 and into a cup 82 or reservoir. As noted, the SMA component 76 may be configured to push the water chamber 72 upwards or to pull the water chamber 72 from the top lip.

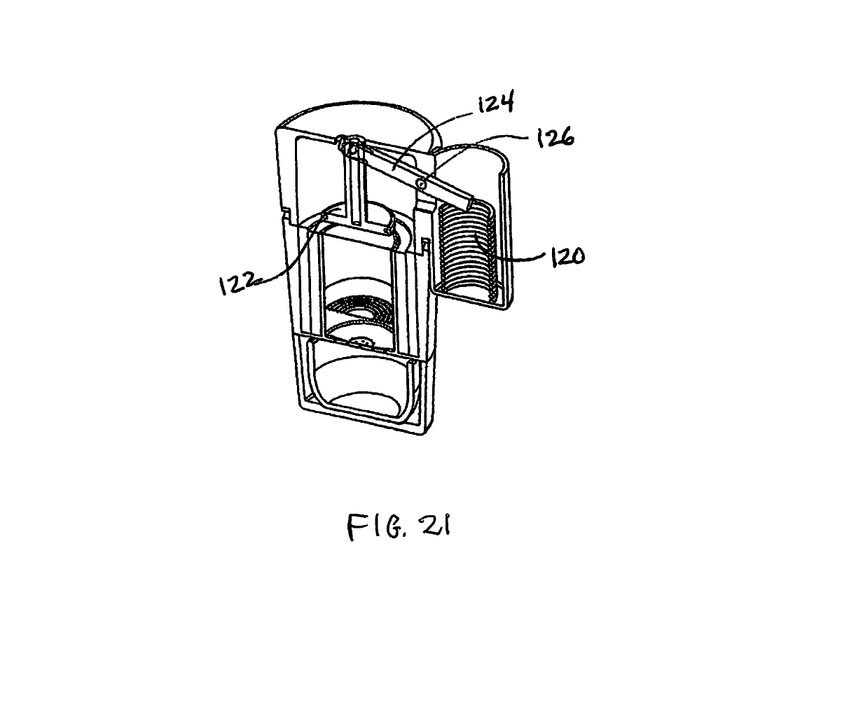

As shown in FIGS. 17 and 18, an exemplary beverage preparation apparatus 90 includes a heating element 92 on the bottom of a base 94. The heating element 92 may be located cylindrically inside the water chamber 96 or outside of it. Alternatively, the heating source 92 may be located externally, internally or a combination of externally and internally.

The heating element 92 and SMA component 98 made be made of the same material, enabling a current to be passed to the heating element 92. Having the Af and desired temperature correlate results in the SMA component 98 activating, causing the water at the desired temperature to pass through the coffee up and out a spout 100.

As shown in FIGS. 19 and 20, a moka pot/macchinetta 110 can be retrofitted with many of the elements of the beverage preparation apparatus described above.

As shown in FIG. 21, the spring 120 may be offset from the piston 122 and interfaced by one or more levers 124. A position, such as a pin, of an axis of rotation 126 on the lever 124 may be altered to enable different spring forces to create different loads on the piston 122. For example, a weak spring with a sufficient lever arm may apply a significant load on the piston 122.

In other embodiments, there may be more than one spring component to increase available spring force. In one example, the spring turns a gear to convert the spring motion to a forceful translation of the piston 122.

SMA components may be positioned relative to the axis of the lever so that one or more springs push the lever and simultaneously one or more springs pull the lever(s), thereby increasing the force. Optionally, multiple springs may work in unison to move the piston 122. For a given spring force, the pressure on the water may be changed by varying the chamber diameter and the piston 122 diameter and/or coffee exit diameter.

The effort mentioned embodiments may utilize a typical rang that is preloaded by mechanical, electrical or manual methods. When the water reaches the desired temperature, the spring is released by mechanical, electrical, SMA actuator or other means, in the spring force is applied to the piston 122 directly or indirectly via a lever, a gear, or other method.

An additional embodiment is to have a release mechanism, such as a solenoid, SMA actuator, mechanical stopper, friction contact, or other, that enables the SMA spring to reach the full or close to full expansion or compression force before the force is transferred to the piston 122. The rationale is that when reaching warm temperatures before SMA activation there is an increase in the vapor pressure of the water as well as increased pressure of the gas (pocket of air in the chamber) that will begin to apply pressure on the water pass through for coffee grinds prematurely.

An alternate method of overcoming a detrimental effect of increased pressure prior to optimal string activation is to place the coffee capsule unsharp pins located at the bottom of the chamber. When the vapor pressure and gas pressure increase, it will not have any effect on the coffee production. Only when the piston begins to advance into the chamber, the piston will push the capsule onto the pins such that they puncture the capsule enabling the water to pass through.

An alternate option is to have the SMA component surround the water chamber or water and coffee chamber. When the water reaches the requisite temperature, the SMA component is he and Ben it compresses radially and squeezes the chamber such that the pressure in the chamber increases and the hot water passes the coffee grinds and out to the cup. In this embodiment, the SMA component may also be that heating element in a manner that the water temperature coincides with the activation temperature of the SMA component.

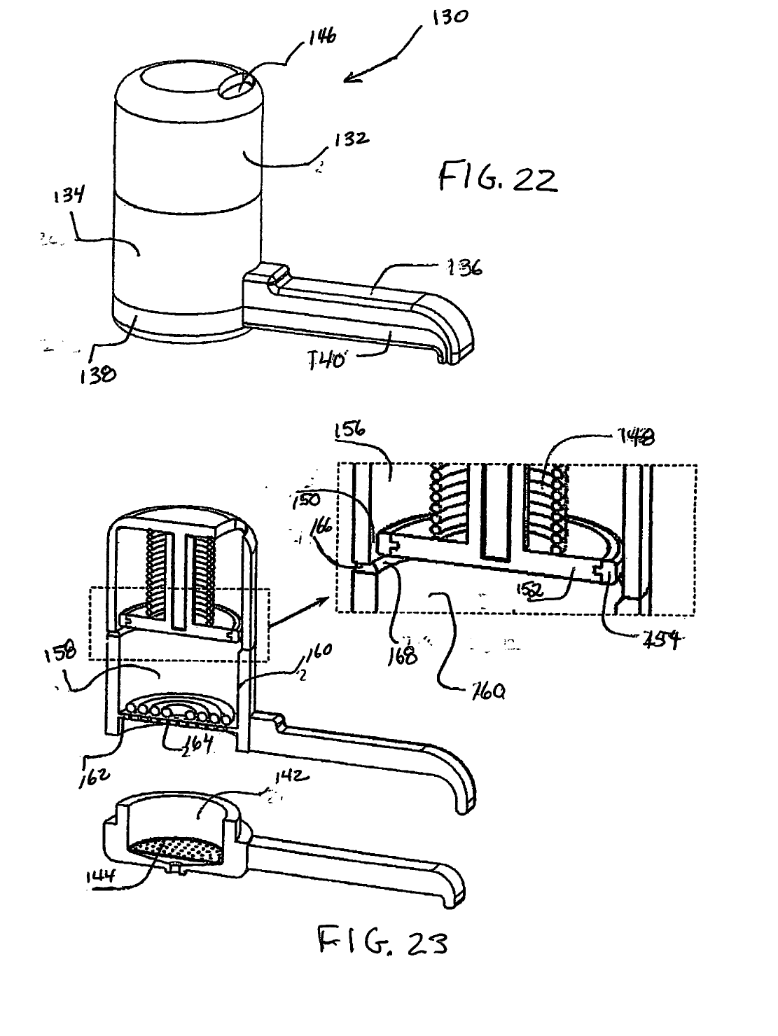

As shown in FIGS. 22 and 23, according to another embodiment of the invention, a beverage preparation apparatus 130 includes a lid 132 rigidly attached to a central body 134 having a handle 136. There is a bottom chamber 138 that has a handle 140 such that handle 140 aligns with handle 136 when the bottom chamber 138 is locked to the central body 134. The bottom chamber 138 separates from the central body 134 to expose a coffee chamber 142 and filter plate 144. Coffee is placed in the coffee chamber 142 and the bottom chamber 142 is locked to the central body 132.

Water is poured into the lid 132 through an opening 146. When the spring 148 is in its compressed state it is aligned with a lower part of the lid 132 such that there is a gap 150 between the piston 152 with attached o-ring 154 and the inner wall 156 of the lid 132. This gap 150 enables water that is poured through the opening 146 to enter the water chamber 158.

The inner surface 160 of the central body 134 fits up to the o-ring 154 to make a water tight fit. A heating element may be inside the water chamber 158 or outside the water chamber 158. A plate 162 with small holes 164 is located at the bottom of the water chamber 158 to prevent water from spilling out the water chamber 158 prematurely. There are one or more small openings 166 at the top of the central body 134 that act as a spill out if excessive water is poured into the apparatus 130.

The water is heated and at the requisite temperature, the spring 148 begins to expand and push the piston 152 downward. There is an angled surface 168 guides the piston 152 concentrically into the water chamber 158 to push hot water through the coffee and into the cup.

In another embodiment, a beverage preparation apparatus includes a water chamber with a telescoping or accordion/bellows configuration. When the piston presses the chamber from one end the telescoping sections overlap one another and reduce the chamber volume. This forces water past the coffee and out. In the bellows configuration, the water chamber collapses enabling the piston to press the water through the coffee.

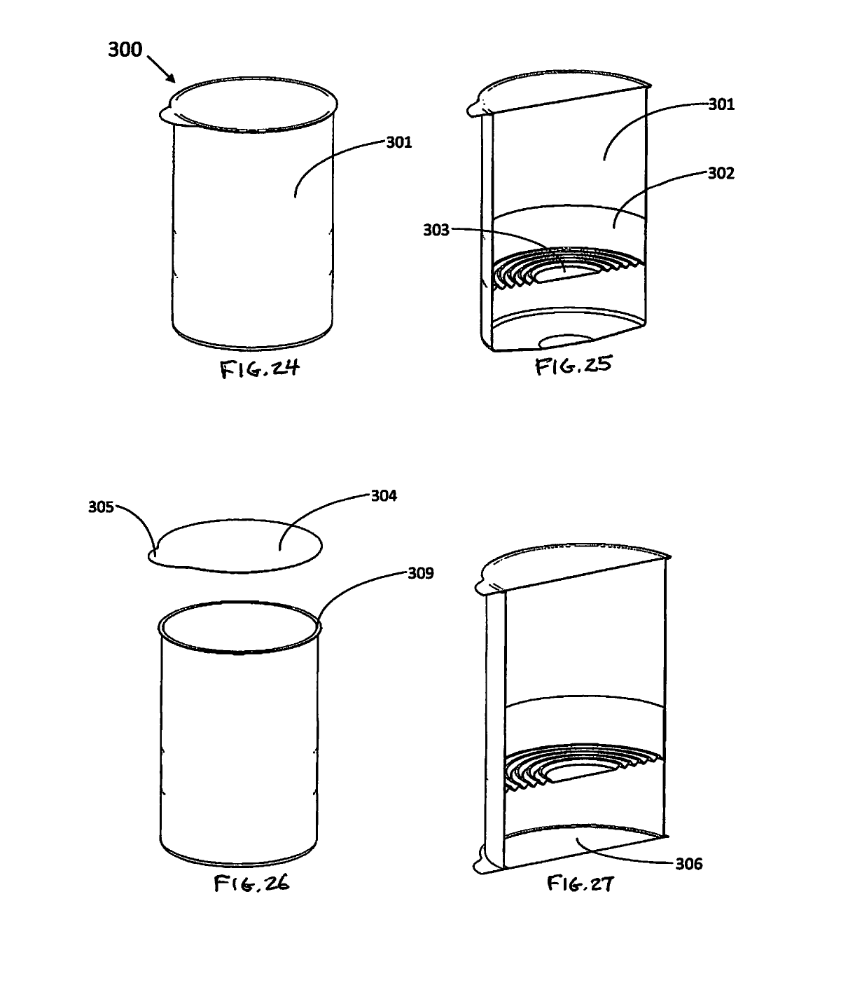

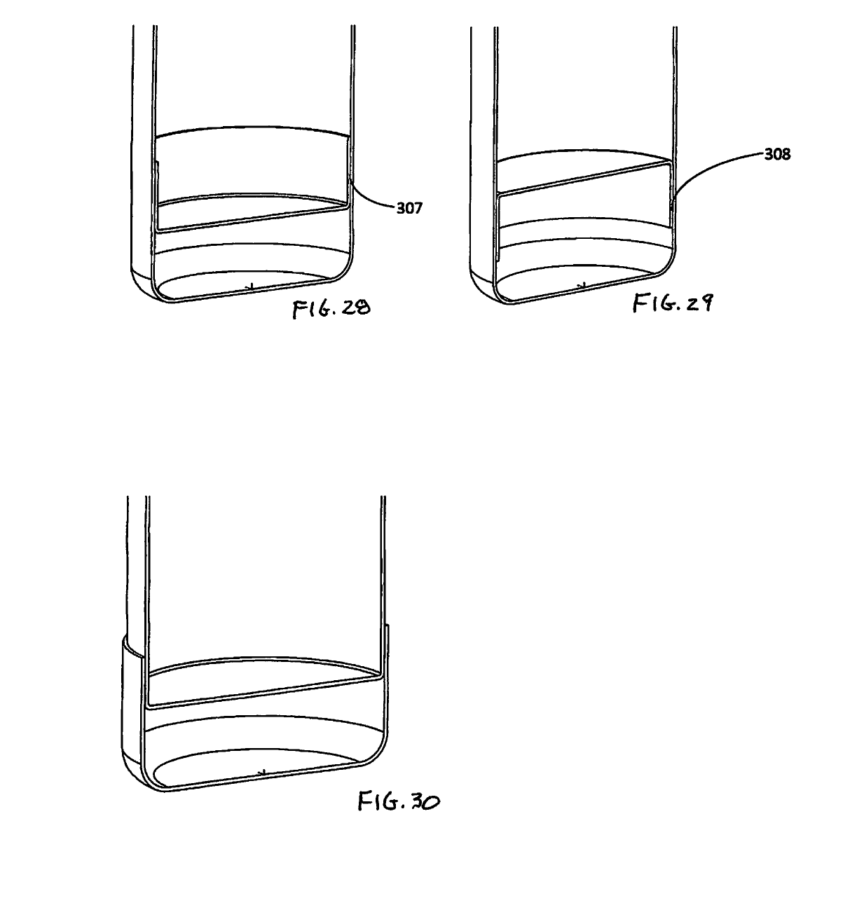

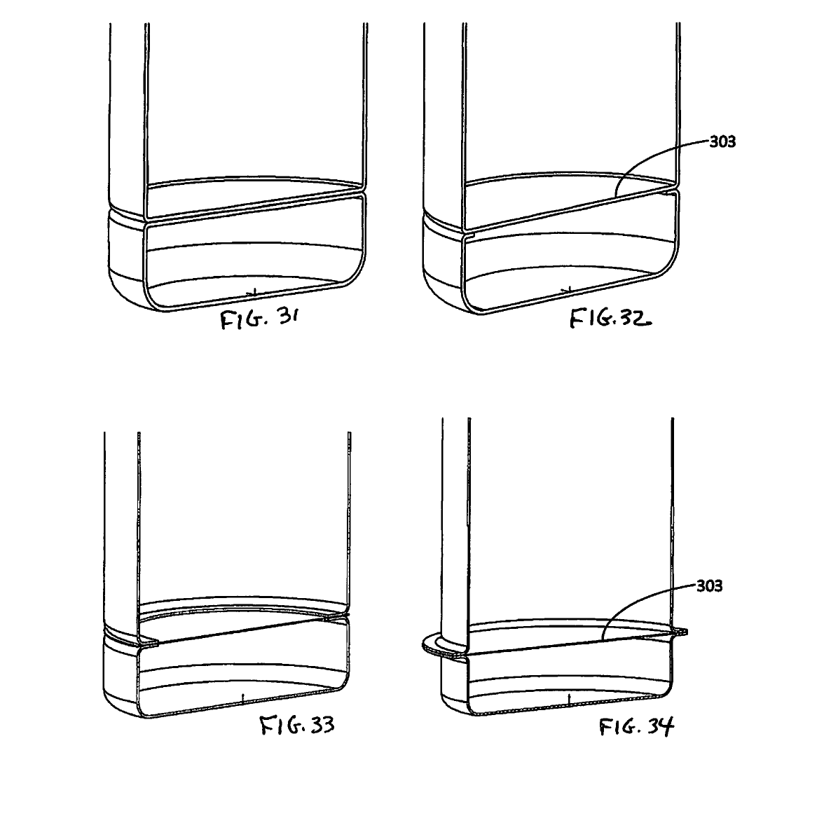

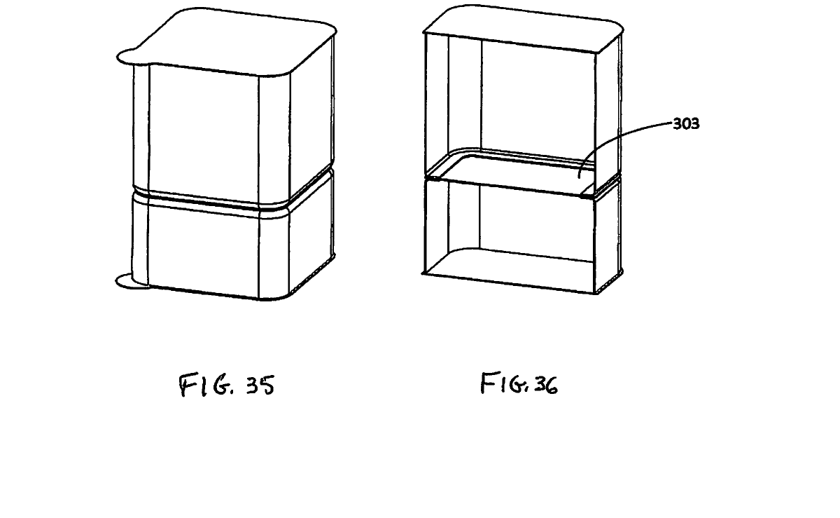

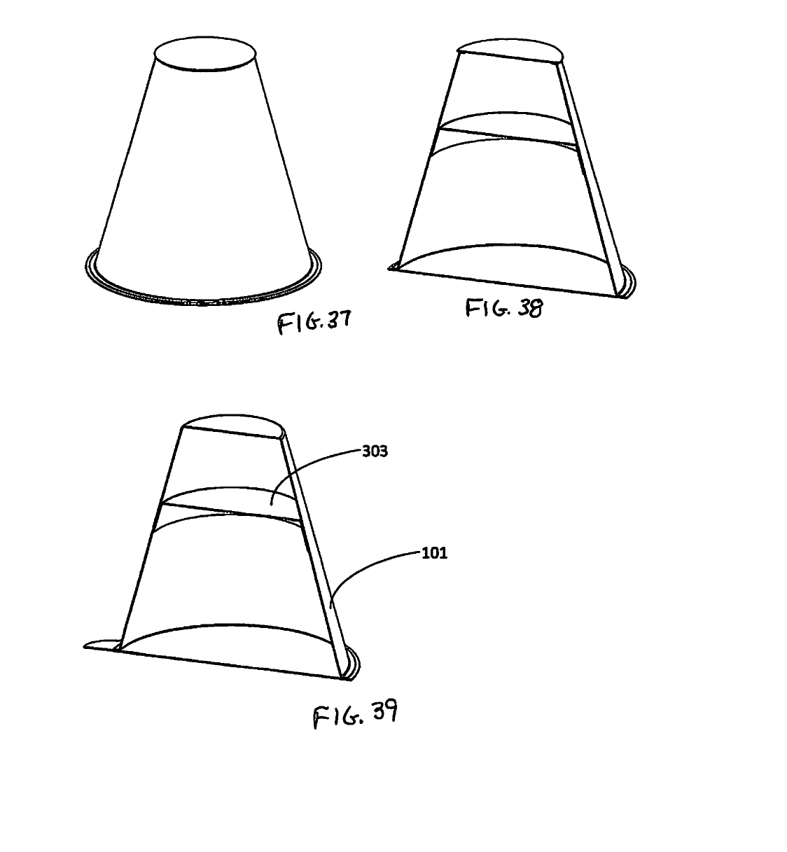

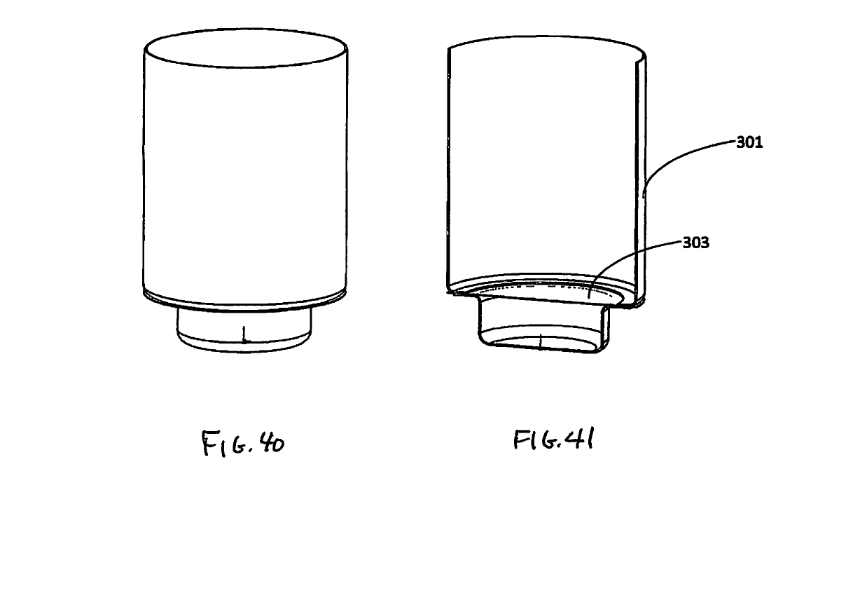

As shown in FIGS. 24 through 41, a multi-chambered capsule 300 includes one or more thin-walled outer shells 301 and/or one or more then diaphragms 303, separating one volume from another volume.

The capsule 300 has a lid 304 made of a thin metal, a polymer, or combination thereof, which may have one or more protrusions 305 for grasping, to enable the separation or peeling off of the lead 304 from the capsule 300. Optionally, the lid 304 may be shaped rather than flat. The lid 304 may be attached to the capsule 300 with adhesive, ultrasonic welding or other method. The attachment of the lid 304 may be on a thin left 309, internally, externally or a combination thereof.

The capsule 300 may have an additional link on the opposite side 306 of the capsule 308 link each volume to be opened separately or simultaneously.

The diaphragm 303 may be flat, undulated, corrugated, ridged, ribbed, wavy or similar area that diaphragm 303 may be attached to the capsule 300 with it he says, ultrasonic welding or other method.

The interface between the chambers or audience may be internally, externally, flash, parallel or similar. The interface direction may be upwards 307, downwards 308, or a combination. The interface between the chambers or volumes may be in combination with the diaphragm or separately.

The shape of the capsule may be round, square, oh, elliptical, chronic, and so forth, or combinations thereof.

The capsule 300 may have different chambers with different sizes, e.g., Heights, diameters, dimensions, volumes and so forth.

Inside one or more of the chambers there may be an element that may pierce the diaphragm, thus enabling the transfer of material from one volume to the other and/or out of the capsule 300. The development may either move or be moved towards the divider or the divider may be moved towards the piercing element.

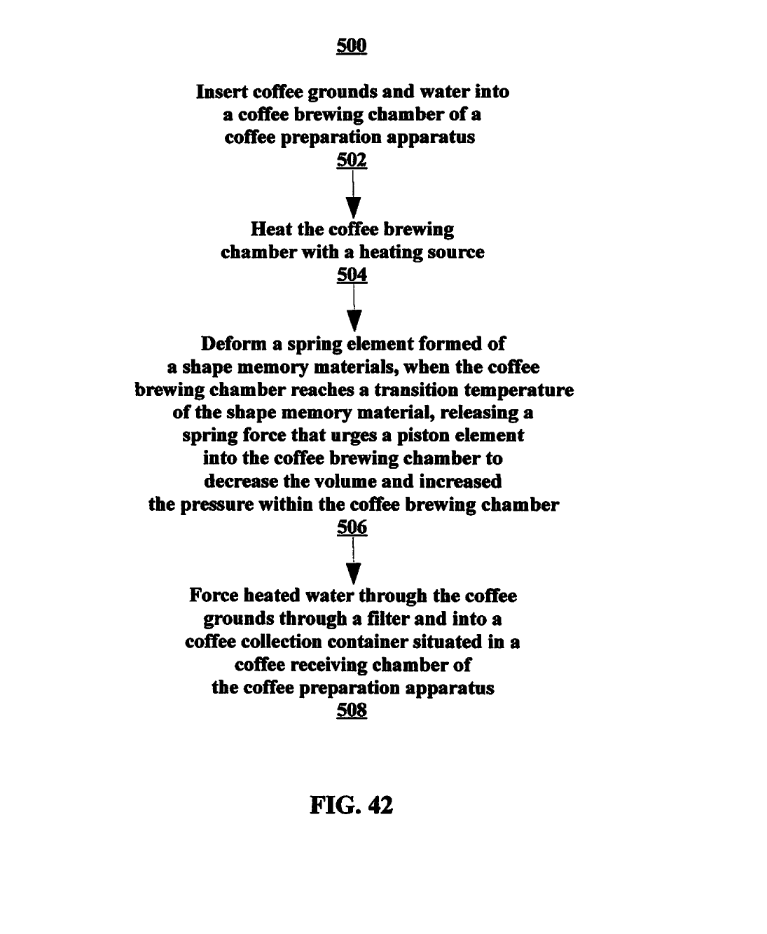

As shown in FIG. 42, a coffee preparation process 500 includes inserting (502) coffee grounds and water into a coffee brewing chamber of a coffee preparation apparatus.

Process 500 includes heating (504) the coffee brewing chamber with a heating source.

Process 500 includes deforming (506) a spring element formed of a shape memory materials, when said coffee brewing chamber reaches a transition temperature of said shape memory material, releasing a spring force that urges a piston element into the coffee brewing chamber to decrease the volume and increased the pressure within the coffee brewing chamber.

Process 500 includes forcing (508) heated water through the coffee grounds through a filter and into a coffee collection container situated in a coffee receiving chamber of the coffee preparation apparatus.

The foregoing description does not represent an exhaustive list of all possible implementations consistent with this disclosure or of all possible variations of the implementations described. A number of implementations have been described. Nevertheless, it will be understood that various modifications may be made without departing from the spirit and scope of the systems, devices, methods and techniques described here. Accordingly, other implementations are within the scope of the following claims.

What is claimed is:

1. A beverage preparation apparatus comprising:
a coffee link chamber for receiving coffee grounds and water;
a coffee receiving chamber for receiving prepared coffee;
the heating source operative check heat for coffee brewing chamber;
at least one biasing element formed of a shape memory materials; and
at least one piston element couples to the biasing element;
whereby when the coffee brewing chamber reaches a transition temperature of the shape memory material, a biasing element deforms, releasing a spring force urging the piston element into the coffee brewing chamber to decrease the volume and increase the pressure within the coffee brewing chamber, and forcing heated water through the coffee grounds through a filter and into a coffee collection container situated in the coffee receiving chamber.

2. The beverage preparation apparatus of claim 1 wherein the biasing element reverts to its undeformed state after the coffee rolling chamber has cooled below the transition temperature, retracting the piston element from the coffee brewing chamber to increase a volume and decrease a pressure within the coffee brewing chamber.

3. The beverage preparation apparatus of claim 1 wherein the shape memory materials is a nickel titanium alloy.

4. The beverage preparation apparatus of claim 1 wherein of biasing element extends and pushes against the piston element when the coffee brewing chamber reaches the transition temperature.

5. The beverage preparation apparatus of claim 1 wherein an electric current is applied to the biasing element upon the activation of the heating source to heat the biasing element.

6. The beverage preparation apparatus of claim 1 wherein the biasing element contracts and pulls against the piston element when the coffee brewing chamber reaches the transition temperature.

7. The beverage operation apparatus of claim 1 further comprising a cooling element couple to the biasing element, the cooling element operative to further cool biasing element after beverage preparation has been completed.

8. The beverage preparation apparatus of claim 1 further comprising a counterforce element coupled to the piston element, the counterforce element operative to apply a force to retract the piston element from the coffee brewing chamber after beverage preparation has been completed.

9. The beverage preparation apparatus of claim 1 wherein the biasing element is fixedly attached to a lewd portion situated adjacent to the coffee brewing chamber.

10. The beverage preparation apparatus of claim 1 wherein the biasing element is selected from the group consisting of flat wires, SMA torsion rod, a matrix of springs in parallel, a matrix of springs in series, leaf springs, hairpin configuration, stacked Belleville configuration, curved spring washers, helical, constant pitch, variable pitch and combinations thereof.

11. The beverage preparation apparatus of claim 1 wherein the heating source is selected from the group consisting of an external heat source, an internal heat source, a gas heater, a stovetop, and induction heater, a convection heater, hot plate, a heating element coupled to a portion of an interior of the coffee brewing chamber, the heating element coupled to a portion of an exterior of the coffee brewing chamber, and combinations thereof.

12. The beverage preparation apparatus of claim 1 wherein the heating source comprises the shape memory material.

13. The beverage preparation apparatus of claim 1 wherein the biasing element is offset from the piston element and applies a spring force to the distant element by at least one force conveyance mechanism.

14. the beverage preparation apparatus of claim 13 wherein the force conveyance mechanism is selected from the group consisting of a lever mechanism and a gear mechanism.

15. The beverage preparation apparatus of claim 1 wherein the biasing element is preloaded with a spring force, which is released and applied to the distant element when the coffee brewing chamber reaches the transition temperature.

16. The beverage preparation apparatus of claim 1 further comprising a release mechanism coupled to the biasing element into the distant element, the release mechanism preventing the spring force from being applied to the distant element unless predetermined brewing conditions are reached in the coffee brewing chamber.

17. The beverage preparation apparatus of claim 1 wherein the Pistons element surrounds the coffee brewing chamber and radially compresses the coffee brewing chamber to decrease a volume can increase a pressure there in when the coffee brewing chamber reaches the transition temperature.

18. The beverage preparation apparatus of claim 1 wherein of coffee brewing chamber comprises multiple telescoping sections, which overlapped to reduce a volume of the coffee brewing chamber when the piston element is urged therein.

19. The beverage preparation apparatus of claim 1 wherein the coffee brewing chamber comprises multiple sections that collapse in an accordion like manner to reduce a volume of the coffee brewing chamber when the piston element is urged therein.

20. The beverage preparation apparatus of claim 1 wherein the coffee brewing chamber receives the coffee grounds and water embedded within a single capsule divided into separate compartments.

21. The beverage preparation apparatus of claim 20 wherein the coffee brewing chamber comprises a surface with puncturing elements for puncturing the capsule.

22. The beverage preparation apparatus of claim 20 wherein the capsule contains a substance selected from the group consisting of coffee grounds, water, milk, sugar, honey, artificial sweetener or combinations thereof.

23. The beverage preparation apparatus of claim 20 wherein the capsule comprises at least one divider for dividing between the separate compartments and further comprises at least one puncturing element for puncturing one of the dividers, enabling a transfer of a substance out of the respective compartment.

24. A beverage preparation capsule comprising multiple compartments separated by dividers, at least one of the dividers comprising coffee grounds, wherein the capsule is inserted into a coffee brewing chamber of a coffee preparation apparatus, the capsule punctured by a puncturing element at a predetermined time, thereby releasing the coffee grounds to enable the percolation thereof.

25. A coffee preparation method comprising:
inserting coffee grounds and water into a coffee brewing chamber of a coffee preparation apparatus;
heating the coffee brewing chamber with a heating source;
deforming a biasing element formed of a shape memory materials, when said coffee brewing chamber reaches a transition temperature of said shape memory material, releasing a spring force that urges a piston element into the coffee brewing chamber to decrease the volume and increased the pressure within the coffee brewing chamber; and
forcing heated water through the coffee grounds through a filter and into a coffee collection container situated in a coffee receiving chamber of the coffee preparation apparatus.
